(19) United States
(12) Patent Application Publication
(10) Pub. No.: US 2005/0273952 A1
(43) Pub. Date: Dec. 15, 2005

(54) Electric toothbrushes

(76) Inventors: John Geoffrey Chan, Loveland, OH (US); Wang Ping, Beijing (CN)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/206,542

(22) Filed: Aug. 18, 2005

Related U.S. Application Data
(63) Continuation of application No. 10/410,038, filed on Apr. 9, 2003.

(51) Int. Cl. A61C 17/22

(52) U.S. Cl. 15/22.1; 15/22.2; 15/28

(57) ABSTRACT

An electric toothbrush is provided. The electric toothbrush has an elongate body having a handle, a head, and a neck extending between the handle and the head. The body has an interior chamber with a motor. A shaft is operatively connected to the motor. A first movable bristle carrier is disposed on the head. The shaft is operatively connected to the first bristle carrier to impart motion thereto. The first bristle carrier has a first composite tuft formed from a plurality of closely spaced bristle tufts and a plurality of second bristle tufts. The second tufts have a height that is greater than a height of the first composite tuft. The bristles of the first composite tuft having free ends and the bristles of the second tufts having free ends. The total surface area of the bristles of the first composite tuft is greater than the total surface area of the bristles of the second tufts, and the plurality of second tufts are disposed adjacent a portion of a perimeter of the composite tuft to form a first recessed region.

### CROSS REFERENCE TO RELATED APPLICATION

This is a continuation of application Ser. No. 10/410,038, filed Apr. 9, 2003, the substance of which is incorporated herein by reference.

### FIELD OF THE INVENTION

The present invention relates to the field of toothbrushes, and more particularly, the present invention relates to the field of electrically powered toothbrushes.

### BACKGROUND OF THE INVENTION

Most known electric toothbrushes utilize a single bristle carrier that is powered or otherwise driven by an electric motor incorporated in the toothbrush. The bristle carriers in these toothbrushes generally undergo rotary motion. There is a desire to promote the retention of toothpaste or dentifrice composition on a movable bristle carrier of an electric toothbrush, and particularly, along the interface between the ends of the bristles or cleaning elements and the surface of the teeth. In an electric toothbrush, powered motion of a bristle carrier may eject the dentifrice material from the bristle carrier, thereby possibly diminishing the effectiveness and/or concentration of agents within the dentifrice material. These agents can include anticaries agents, fluoride agents, anticalculus agents, antimicrobial agents, desensitizing agents, anesthetic agents, anti-inflammatory agents, abrasives, and whitening agents. As such, there is a desire to provide improved designs for retaining a dentifrice material while still providing effective cleaning of the teeth. Still further, there is a desire to provide these benefits in combination with a plurality of movable bristle carriers.

### SUMMARY OF THE INVENTION

An electric toothbrush is provided. The electric toothbrush has an elongate body having a handle, a head, and a neck extending between the handle and the head. The body has an interior chamber with a motor. A shaft is operatively connected to the motor. A first movable bristle carrier is disposed on the head. The shaft is operatively connected to the first bristle carrier to impart motion thereto. The first bristle carrier has a first composite tuft formed from a plurality of closely spaced bristle tufts and a plurality of second bristle tufts. The second tufts have a height that is greater than a height of the first composite tuft. The bristles of the first composite tuft having free ends and the bristles of the second tufts having free ends. The total surface area of the bristles of the first composite tuft is greater than the total surface area of the bristles of the second tufts, and the plurality of second tufts are disposed adjacent a portion of a perimeter of the composite tuft to form a first recessed region.

### BRIEF DESCRIPTION OF THE DRAWINGS

The present invention may take form in various components and arrangements of components, and in various techniques, methods, or procedures and arrangements of steps. The referenced drawings are only for purposes of illustrating preferred embodiments, they are not necessarily to scale, and are not to be construed as limiting the present invention.

It is believed that the present invention will be better understood from the following description taken in conjunction with the accompanying drawings in which:

FIG. 1 is perspective view of a toothbrush in accordance with the invention.

FIG. 2 is a partial perspective view of the toothbrush of FIG. 1, wherein a portion has been removed to expose interior details.

FIG. 3 is partial perspective view of the toothbrush head of FIG. 1.

FIG. 4 is a top planar view of the toothbrush head of FIG. 3.

FIG. 5 is a cross-sectional elevation view of the toothbrush head of FIG. 4, taken along line 5-5 thereof.

FIGS. 6A to 6D are perspective views of integral tufts in accordance with the present invention.

FIGS. 7A to 7D are top plan views of arrangements of the integral tufts of FIGS. 6A to 6D on a toothbrush head having two movable bristle carriers.

FIG. 8 is a partial perspective view of another toothbrush head in accordance with the present invention.

FIG. 9 is a partial perspective view of yet another toothbrush head in accordance with the present invention.

FIG. 10 is a partial perspective view of still another toothbrush in accordance with the present invention.

### DETAILED DESCRIPTION OF THE INVENTION

The present invention relates to electric toothbrushes and electric toothbrush heads having one or more movable bristle carriers, preferably two, having one or more recessed regions generally defined by bristle tufts or cleaning elements retained on the bristle carrier. The recessed regions are adapted for retaining toothpaste or dentifrice material. The floor of the recessed region preferably has an irregular surface that is also continuous to assist with retaining the dentifrice material. The floor of the recessed region may be formed from composite tufts or integral tufts. These aspects are described in greater detail below.

The present invention can assist in retaining a dentifrice material in contact with the teeth and/or gums during use of an electric toothbrush. The dentifrice material can include agents that act upon the teeth and/or gums, such as anticalculus agents, fluoride agents, antimicrobial agents, dentinal desensitizing agents, anesthetic agents, antifungal agents, anti-inflammatory agents, selective H-2 antagonists, anticaries agents, nutrients, and mixtures thereof.

The fluoride agents can include sodium fluoride; stannous fluoride; indium fluoride; organic fluorides such as amine fluorides, and sodium monofluorophosphate.

The anticalculus agents can include polyphosphates and salts thereof; polyamino propane sulfonic acid (AMPS) and salts thereof; polyolefin sulfonates and salts thereof; polyvinyl phosphates and salts thereof; polyolefin phosphates and salts thereof; diphosphonates and salts thereof; phosphonoalkane carboxylic acid and salts thereof; polyphosphonates and salts thereof; polyvinyl phosphonates and salts thereof; polyolefin phosphonates and salts thereof; polypeptides; pyrophosphates; and mixtures thereof.

The whitening agents can include peroxides; perborates; percarbonates; peroxyacids; persulfates; metal chlorites; and combinations thereof.

The abrasive agents can include silicas including gels and precipitates, insoluble sodium polymetaphosphate, hydrated alumina, calcium carbonate, dicalcium orthophosphate dihydrate, calcium pyrophosphate, tricalcium phosphate, calcium polymetaphosphate, and resinous abrasive materials such as particulate condensation products of urea and formaldehyde. Other abrasives can include thermo-setting polymerized resins such as melamines, phenolics, ureas, melamine-ureas, melamine-formaldehydes, urea-formaldehyde, melamine-urea-formaldehydes, cross-linked epoxides, and cross-linked polyesters.

Before describing the various preferred embodiments, it is instructive to define various types of motions. As used herein, the term “angular motion” refers to any angular displacement. “Linear motion” is movement along a straight or substantially straight, line or direction. “Curvilinear motion” is movement that is neither completely linear nor completely angular but is a combination of the two (e.g., curvilinear). These motions can be constant or periodic. Constant motion refers to motion that does not change direction or path (i.e., is unidirectional). Periodic motion refers to motion that reverses direction or path. Constant angular motion is referred to as rotary motion, although features herein may be described as “rotatably mounted” which is intended to merely mean that angular motion, whether periodic or constant, is possible. Periodic angular motion is referred to as “oscillation”. Curvilinear motions can also be either constant (i.e., unidirectional) or periodic (i.e., reverses direction). Periodic linear motion is referred to as “reciprocation”. “Orbital motion” is a type of angular motion about an axis that is distinct from and is some distance apart from the center of the moving component, e.g. a shaft. Orbital motion may be either constant angular motion or periodic angular motion.

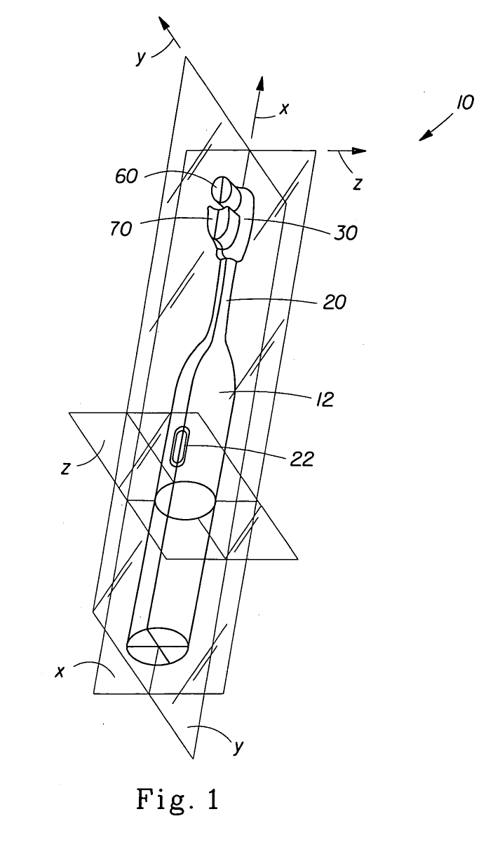

Referring to FIG. 1, the above-described motions can also occur along one or more axes. Accordingly, motion is described herein as being either one, two, or three dimensional motion depending upon the number of axial coordinates required to describe the position of a bristle carrier during its movement. One dimensional motion is motion that can be described by a single coordinate. Typically, only linear motion can be one dimensional. Two dimensional motion is movement by a bristle carrier that requires two coordinates to describe the path of travel of the bristle carrier. Angular motion that occurs in a single plane is two dimensional motion. Three dimensional motion is movement by a bristle carrier that requires three coordinates to describe the path of travel of the bristle carrier. An example of three dimensional motion is movement by a bristle carrier in the path of a helix.

Since most of the bristle carrier motions described herein can be modified by adjusting various structural features, the description of a motion herein shall be automatically understood to accommodate these variations. For example, a motion that is described as oscillating about an axis can also include components of other motions (e.g., a reciprocating linear motion). Motions that are intended to exclude such modifications shall be described herein with the modifier “primarily” (e.g., “primarily oscillating” or “primarily reciprocating”) and are intended to exclude significant other types motion, but not other motions that might be incidental from manufacturing tolerances or variabilities or where it is difficult to completely eliminate another type of motion completely from the bristle carrier, as is sometimes the case. All motions described herein may be restricted to primarily the motion described if desired. The motions are best described in terms of the axes X, Y, and Z.

The X axis is generally referred to herein as the longitudinal axis and generally extends along a longitudinal or lengthwise dimension (as seen from the top planar view of the toothbrush) of the toothbrush head or the bristle carrier. For example, a longitudinal axis is an axis passing through the longest dimension of the toothbrush head. The Y axis is transverse, orthogonal or perpendicular to the X axis and generally bisects the toothbrush head into its left and right halves. The Z axis is transverse, orthogonal or perpendicular to the X and Y axes. It will be appreciated that axis orientations need not be exactly orthogonal or perpendicular to another axis and that some deviation from 90 degrees between the axes, particularly when these axes are used to describe a direction of motion. It should be understood that any axis orientation herein can be modified by the terms “generally” or “substantially” (e.g., “generally transverse” or “substantially transverse”). The word “substantially” implies some angular deviation, but not as much angular deviation from 90 degrees as the word “generally”. No modifier indicates slight to no deviation from 90 degrees. Thus, a motion that is described as occurring about a first axis transverse to a second axis implies that the motion occurs at a 90 degree angle to the second axis with some slight deviation permitted (e.g., from manufacturing tolerances, etc.). If the motion is generally transverse or substantially transverse, a greater deviation from 90 degrees is contemplated. All the axes described herein can intersect another axis either generally or substantially transverse to said other axis.

Plane X contains the X axis and is generally referred to herein as the plane of the toothbrush or the plane of the toothbrush head. This plane generally extends along the longitudinal dimension of the toothbrush. The Y plane contains the Y axis and extends through the toothbrush and is perpendicular to the X plane. The Y plane either bisects the toothbrush or is parallel to a plane that does. The Z plane is perpendicular to both the X plane and the Y plane and contains the Z axis.

Furthermore, it is useful to address the terminology used in describing the preferred embodiment toothbrushes, bristle carriers, and the various drive mechanisms. As used herein, the term “forward” refers to the direction from the handle to the head while the term “rearward” refers to the direction from the head to the handle. A longitudinal direction is a direction that generally corresponds to a longitudinal or X axis but which may not lie in the same plane as the axis. For example, the longitudinal axes of a shaft and a bristle carrier may not extend in the same plane but generally extend in the same direction from a top planar view. Similarly, a neck and head that are angled with respect to each other may not have longitudinal axes that extend in the same plane, but do have axes that extend in the same general longitudinal direction from a top planar view. Many of the preferred embodiment electric toothbrushes typically have an elongated head with a longitudinal axis passing through the longest dimension thereof. This axis typically extends in the same general direction as the longitudinal axes of the toothbrush neck and/or shaft. This axis is generally referred to as the longitudinal axis of the toothbrush. By the phrase “same general direction,” some angular deviation is contemplated between the axes.

Furthermore, it is useful to define the terms “fixed” or “static” bristles, and the term “movable” bristles. The terms fixed or static bristles refer to bristles that are secured or affixed to the toothbrush head or body of the toothbrush or other component thereof so that the bristles, and specifically, the base of the bristles, do not move with regard to the longitudinal axis of the toothbrush. Restated, fixed or static bristles refer to bristles that are affixed to the toothbrush such that their base or point of attachment does not move with respect to the toothbrush. It is recognized that the tips or regions distal from the base of a bristle or group of bristles may move as a result of flexing of the bristle. However, the base of a stationary, static, or fixed bristle does not move with respect to the brush. The term movable bristle refers to a bristle in which the base of the bristle moves with respect to the toothbrush, and particularly with respect to the longitudinal axis of the brush. Generally, this configuration is accomplished by affixing or supporting the base of the bristle to a mounting component, i.e. a bristle carrier or holder, that is movable with respect to the brush. Restated, a movable bristle is a bristle that is movable with respect to the longitudinal axis of the brush.

While the present invention is described herein with respect to a toothbrush, it will be appreciated that the present invention also relates to merely a toothbrush head, such as a detachable or replaceable toothbrush as is known in the art. The detachable or replaceable toothbrush head may or may not include a portion of a toothbrush neck and may or may not include a shaft.

Referring to FIGS. 1, 2 and 3, a toothbrush 2 in accordance with the present invention will now be described. The toothbrush 10 comprises an elongated body having a handle 12, a head 30, and a neck 20 extending between the handle 12 and the head 30. A switch 22 is provided or made accessible along the outer region of the body. The switch 22 actuates an electrical motor 24 (FIG. 2) contained within the handle 12 of toothbrush 10. The motor and a drive mechanism as described herein drive one or more bristle carriers disposed near a forward end of the toothbrush. Specifically, the toothbrush 10 further includes a first bristle carrier 60 located adjacent a forward-most first end and a second bristle carrier 70 disposed between the first bristle carrier and the handle 12. As described in greater detail herein, upon activation of the drive mechanism, the first and second bristle carriers undergo a particular combination of motions.

The electrical motor 24 is operatively connected to a shaft 26 that in turn is operatively connected to the first and second bristle carriers. While the shaft 26 of toothbrush 10 is connected to each of the first bristle carriers 60 and 70, it is contemplated that the shaft 26 might be operatively connected to only one of the bristle carriers and the second bristle carrier is driven by the bristle carrier connected to the shaft. The shaft interconnecting the motor with the movable bristles carriers can rotate, oscillate, reciprocate, undergo an orbital motion, or a combination thereof. Gearing 28 may be provided between the shaft 26 and the motor 24 to facilitate transmission of motion between the motor and the movable bristle carriers. A wide array of drive motor and/or gearing configurations may be utilized in the preferred embodiment toothbrushes described herein. For example, various drive mechanisms described in U.S. Pat. Nos. 6,178,579; 6,189,693; 6,360,395; 6,371,294; 5,226,206; 5,524,312; 5,383,242; 5,465,444; 5,504,959; 5,836,030; 4,845,795; 5,404,608; 5,359,747; and 5,617,601 may be utilized. The elongated hollow body also includes an interior chamber containing a voltage source, such as one or more batteries (not shown), for powering the motor 24. A removable end cap is provided to enclose the interior chamber and provide a seal against external agents for the components inside the toothbrush body.

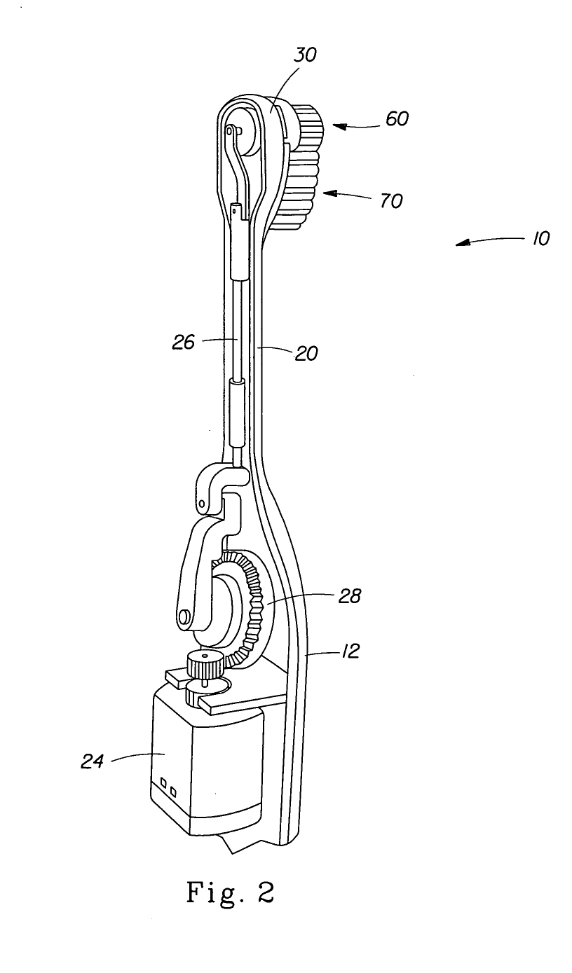

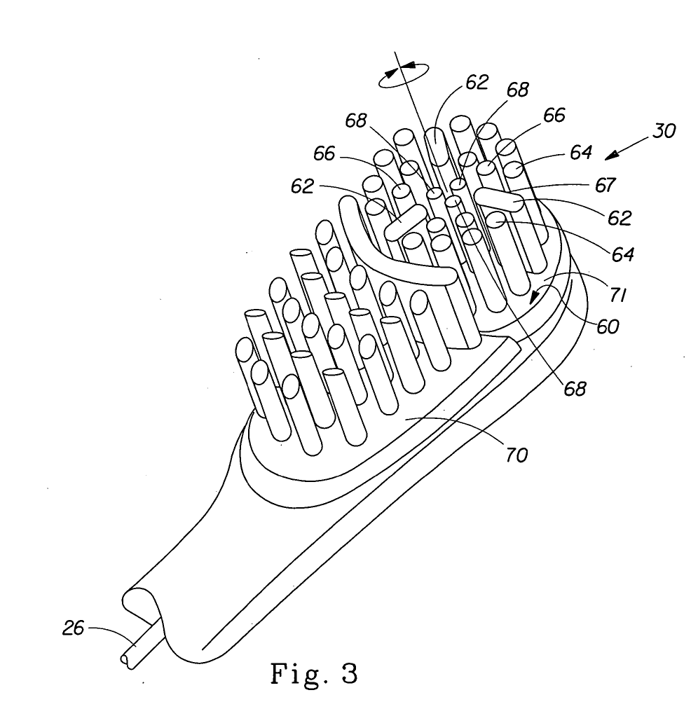

The toothbrushes of the present invention may comprise one, two, three or more movable bristle carriers that may undergo a wide variety of motions. For example, the movable bristle carrier may undergo angular motion, linear motion, curvilinear motion, or orbital motion. The movement of the bristle carrier may be constant or periodic. A preferred motion for the first forward-most movable bristle carrier of the preferred embodiment toothbrushes described herein is an oscillating motion about an axis that is perpendicular to the longitudinal axis of the toothbrush, the toothbrush head, and/or bristle carrier, as shown in FIG. 3. The preferred motion for the second movable bristle carrier of the preferred embodiment toothbrushes described herein is a reciprocating motion in the same general direction as the longitudinal axis of the toothbrush, the toothbrush head, and/or bristle carrier.

One or more of the bristle carriers has one or more recessed regions that serve to retain toothpaste or dentifrice material at the bristle tips during brushing. Maintaining dentifrice between the bristles or cleaning elements can provide improve the efficacy of the agent(s) incorporated in the dentifrice material. Additionally, such recessed regions are particularly beneficial when used in conjunction with one or more movable bristle carriers since such movement tends to cause dentifrice previously applied thereto, to fall away or separate from the brush head upon actuation of the electric toothbrush.

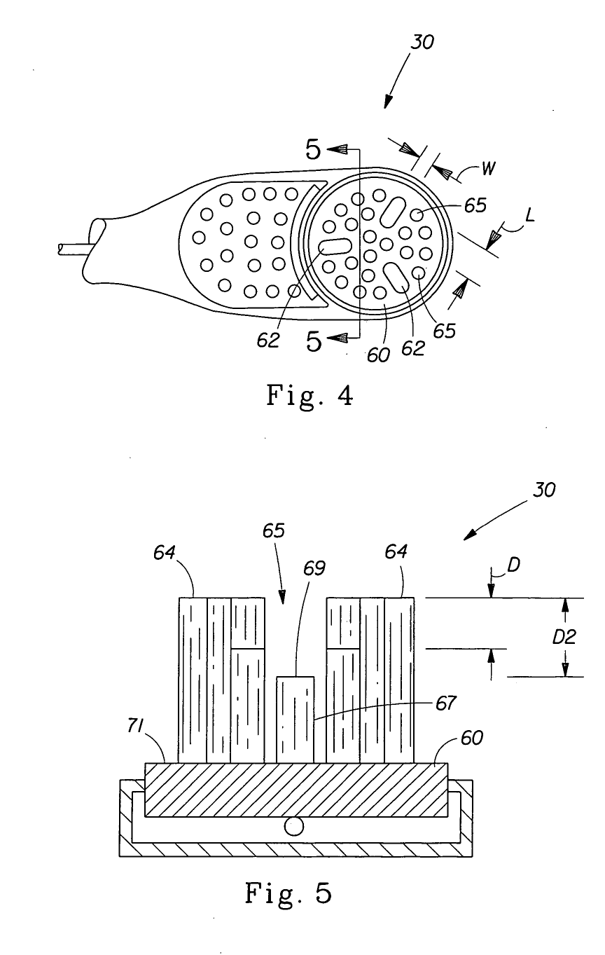

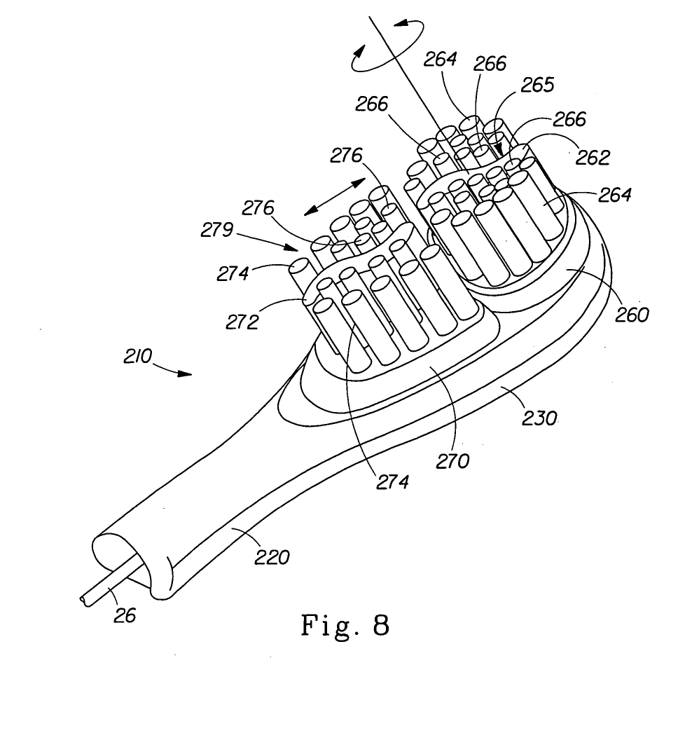

Referring to FIGS. 3, 4 and 5, the first bristle carrier 60 includes three elongate composite tufts 62 that form a floor of three recessed regions 65. The composite tufts 62 are formed from a plurality of closely spaced tufts that, when placed in close relationship, appear to form a single composite tuft 62. Methods for forming the composite tufts 62 are described in U.S. patent publication no. US 2001/0023516. The composite tufts 62 may be formed from between 2 and 6 smaller, closely spaced tufts of bristles. The composite tufts 62 are bordered on two or more sides by taller tufts 64, and in a preferred arrangement, the composite tufts 62 are bordered on each of their elongate sides by the taller tufts 64 and their elongate sides are aligned in a radial direction from the center of the bristle carrier 60. Since the bristle carrier 60 oscillates about an axis that is perpendicular to the longitudinal axis of the toothbrush and/or head, the radial alignment of the tufts 62 on the bristle carrier 60 causes the tufts 62 to perform a broad sweeping motion when in contact with the teeth. This sweeping motion can assist with polishing the teeth, especially when a dentifrice material is retained in a recessed region. For bristle carriers that undergo other motions, it is preferred that the elongate dimension of the tufts 62 is arranged transverse to the direction of motion to provide a sweeping motion across the length of the tuft 62. An example of such an arrangement is shown in FIG. 8, which is discussed more fully hereafter.

The composite tufts 62 can extend from the outer edge of the bristle carrier to the center of the bristle carrier 60. In an alternate embodiment, the elongate sides 67 of the composite tufts 62 are greater than about 50%, 65%, 80% and/or less than about 250% (e.g., a curvilinear elongate side that extends across the entire bristle carrier, such as shown in FIG. 8), 200%, 150% and less than about 90% of the radius R of the bristle carrier 60. The elongate sides 67 may have a length L greater than about 3 mm, or greater than about 4 mm, or greater than about 5 mm or greater than about 6 mm and/or less than about 14 mm, or less than about 12 mm, or less than about 9 mm. The above-described dimensions are also applicable to tufts that are irregularly shaped or circular in shape, in which case the dimension refers to the perimeter of the tuft. The top surface 69 that forms the floor or valley of the recessed region has a width W between about 1 mm and about 3 mm or between about 1.25 mm and about 1.75 mm. The top surface 69, in one embodiment, is substantially flat over the width W to better support and retain the dentifrice material. The total surface area formed by the bristle free ends of the tufts 62 is between about 10% and about 40% of the total surface area formed by the free ends of all the tufts of the first bristle carrier 60. In another embodiment, the surface area formed by the bristle free ends of the tufts 62 is greater than about 15%, or greater than about 20% or greater than about 30% or greater than 35% and/or less than about 40% or less than about 35% or less than about 30% of the total surface area formed by the free ends of all the tufts of the first bristle carrier 60. These preferred ranges provide a good balance between adequate surface area for retaining a dentifrice material and adequate surface area for bristles that primarily clean the teeth (e.g., tall tufts 64).

As best seen in FIG. 5, each of the composite tufts 62 have a surface 69 formed by the free ends of the bristles forming each composite tuft 62. The surface 69 forms the floor or valley of the recessed region. The surfaces 69 of the composite tufts 62 are preferably continuous. A continuous surface is a surface that does not have a significant gap thereacross that extends down to the top surface 71 of the bristle carrier such that the surface is separated into distinct portions. Generally, tufts having a spacing between about 0.5 mm and about 0.7 mm are closely spaced enough to form a composite tuft having a continuous surface, although this spacing can be affected by the angle that the closely spaced tufts form with the top surface 71 of the bristle carrier. The top surface 69 of the composite tufts 62 (which is also the surface that forms the floor of the recessed region 65) is preferably an irregular surface. An irregular surface is a surface having height variations that assist in retaining a dentifrice material. For example, since the tufts 62 are formed from a plurality of bristles, the individual bristle tips, when combined, form an irregular surface. While the surface 69 is irregular at a micro scale, overall, the bristle tops form a substantially flat or planar surface at a macro scale, as best seen FIG. 5. One method of manufacturing the tufts 62 is described in U.S. publication no. US 2001/0023516.

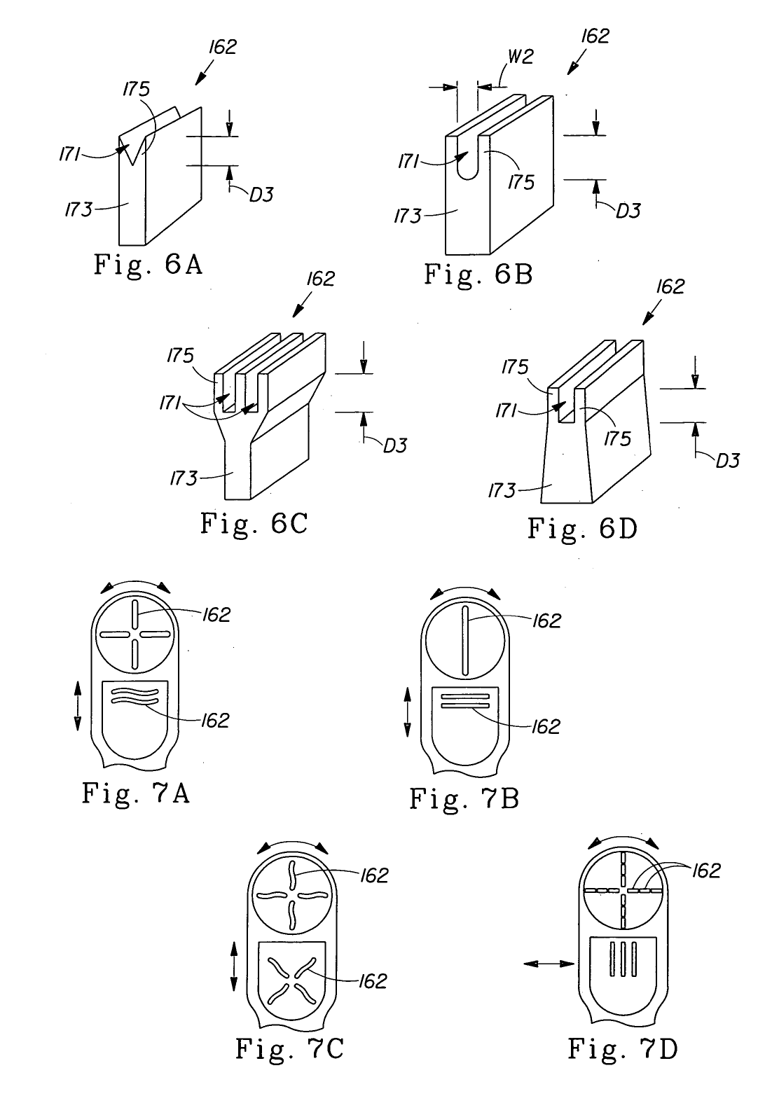

A continuous surface can also be formed by an integral, single, upstanding element that is not formed from a plurality of bristles. For simplicity, these integral elements are referred to herein as integral tufts. Examples of the integral tufts 162 are shown in FIGS. 6A to 6D. Thus, the word “tuft” is used herein to denote both the previously described composite tufts formed from a plurality of bristles as well as integral, upstanding elements which are not formed from bristles but are rather single flexible structures formed from an elastomeric material, such as a thermoplastic elastomer. The integral tufts 162 can be formed by injection molding. Generally, integral tufts can be substituted for composite tufts and vice versa. The free end of the integral tufts 162 have a one or more slits 171 therein. The number of slits can be between 1 and 5, and in an alternate embodiment is between 1 and 3. The slit 171 preferably extends from one side 173 of the integral tuft 171 to the other side so that a pair of flexible upstanding walls 175 are formed. The walls 175 can be the same height or may differ in height. The depth D3 of the slit 171 can be between about 0.5 mm and about 3 mm or between about 1 mm and about 2 mm. The width W2 of the slits 171 is between about 0.5 mm and about 2 mm or between about 0.75 mm and about 1 mm. The slits assist in retaining a dentifrice material during use. The base of the tufts 162 can be provided in a variety of forms. The base might widen, as shown in FIG. 6D, in a direction away from the free end. The shape of the slit, in either a plan or elevation view, might also vary. For example, in an elevation view, the slit might be V-shaped, U-shaped, or irregularly shaped, as shown in FIGS. 6A to 6D. One integral tuft 162 might be provided, as shown in FIG. 3, or a plurality of integral tufts might be positioned adjacent each other as shown in FIGS. 6A to 6D. Or the plurality of integral tufts 162 might be disposed across a bristle carrier with tufts of bristles disposed there between, as shown in FIG. 8. The outer surface of the integral tufts 162 can be provided with surface roughness or protrusions to further enhance the ability of the integral tufts 162 to retain a dentifrice material. The upstanding flexible walls 175 may also assist with both metering or dosing the material disposed within the slits 171 as they flex during use, thereby squeezing the material out of the slit 171, as well as polishing the teeth and/or massaging the gums. The integral tufts described here can also be applied to a manual toothbrush.

Referring to FIGS. 7A to 7C, the integral tufts 162 can be provided in a variety of arrangements on one or more bristle carriers. In the embodiments of FIG. 7, first and second bristle carriers that oscillate and reciprocate, respectively, are illustrated with one or more integral tufts 162. The integral tufts have a slit therein. The integral tufts might have a linear shape (e.g., FIG. 7B), an arcuate shape (e.g., FIG. 7C), or a combination thereof in plan view. Preferably, between 1 and 6 integral tufts 162 might be provided on a bristle carrier, although more could be provided such as in FIG. 7D wherein a plurality of integral tufts are arranged to effectively form a larger continuous tuft. Other bristle carrier movements and arrangements of the integral tufts 162 can be provided.

Referring again to FIG. 5, the tall bristle tufts 64 are disposed about the periphery of the bristle carrier 60 in a circular arrangement. The depth D2 between the tall tufts 64 and the composite tufts 62 is between about 1 mm and about 3 mm and in another embodiment between about 1.5 mm and about 2.5 mm. To provide improved dispensation of a dentifrice material from the recessed regions, intermediate bristle tufts 66 can optionally be provided between the tall tufts 64 and the center of the bristle carrier 60. The intermediate tufts 66 have a height that is between the height of the tall tufts 64 and the composite tufts 62. The intermediate tufts 66 are provided in a circular arrangement. The depth D between the tall tufts 64 and the intermediate tufts 66 is between about 0.25 mm and about 1 mm, and in an alternate embodiment is between about 0.5 mm and about 0.75 mm.

At least some of the tall tufts 64 and the intermediate tufts 66 are disposed adjacent, preferably immediately adjacent, a portion of the perimeter of the composite tufts 62 to form the recessed regions. More preferably, at least some of the tall and/or intermediate tufts are disposed on opposing sides of the perimeter of the composite or integral tufts to form the recessed region. The tall and intermediate tufts may partially or completely encircle the shorter composite and integral tufts. Preferably, the tall and/or intermediate tufts are disposed adjacent at least about 50%, or least about 60%, or at least about 70%, or at least about 80%, or at least about 90% and/or less than about 100%, or less than about 90%, or less than about 80%, or less than about 70% of the perimeter of the composite (or integral) tuft to form a recessed region. While the tall and intermediate tufts have been shown in a preferred arrangement, it is contemplated that tall tufts and be substituted for intermediate tufts and vice versa. Further, while the tall and intermediate tufts have been shown with substantially planar free end surfaces, it is contemplated that a profile can be provided at the free ends of the tall and intermediate tufts.

Optionally disposed near the center of the bristle carrier 60 are three center bristle tufts 68 that have a height about the same as the height of the composite tufts 62. In an alternate embodiment, the three center bristle tufts 68 can have a height that is less than the height of the composite tufts 62. Since the oscillating motion at the center of the bristle carrier 60 is small compared to the movement near the periphery of the bristle carrier 60, the center tufts 68 can be spaced apart so that discrete tufts are formed rather than a continuous surface stretching across and between the center tufts 68. The tufts 62, intermediate tufts 66, the center tufts 68, and tall tufts 64 form a cup or U-shaped profile in plan view, as best seen in FIG. 5. This shape can facilitate retaining and dispensing a dentifrice material from the recessed regions.

FIG. 8 is a perspective view of another toothbrush 210 in accordance with the present invention. The toothbrush 210 comprises an elongated body having a handle, a head 230, and a neck 220, extending between the handle and the head 230, as previously shown and described with respect to FIG. 1. The toothbrush 210 further includes a first bristle carrier 260 and a second bristle carrier 270 located adjacent the neck 220. The first bristle carrier 260 oscillates about an axis perpendicular to the longitudinal axis of the toothbrush and/or head, and the second bristle carrier 270 reciprocates in a direction along the longitudinal axis of the toothbrush and/or head, although other motions can be provided. The first bristle carrier 260 includes an elongate composite tuft 262. The elongate composite tuft is preferably disposed in a line generally extending across the diameter of the face of the bristle carrier 260. This line may be straight, arcuate, or a combination thereof. The first bristle carrier 260 further includes a plurality of tall tufts 264 that are disposed about at least a portion, and preferably a majority of the outer periphery of the bristle carrier 260. The bristle carrier 260 also includes a plurality of intermediate tufts 266 generally disposed within the interior region of the face of the carrier 260. Preferably, some of the intermediate tufts 266 are disposed between some of the tall tufts 264 and the composite tuft 262. The intermediate tufts 266 have a height between the height of tall tufts 264 and the composite tuft 262. The intermediate tufts 266 are disposed along the sides of the composite tuft 262. The intermediate tufts 266 are disposed about a portion of the perimeter of the composite tuft 262 to form a first recessed region 265.

The second bristle carrier 270 includes an elongate second composite tuft 272 preferably extending along the length, or substantially so, of the face of the second bristle carrier 270. The elongate composite tuft 272 is preferably arranged in a line and most preferably in an arcuate line that extends generally in the same direction as the longitudinal axis of the toothbrush 210. The elongate composite tuft 272 has a forward-most end that generally aligns with the rearward-most end of the composite tuft 262 of the first bristle carrier 260. Also disposed on the second bristle carrier 270 are a plurality of tall tufts 274 that are disposed along the outer periphery of the bristle carrier 270. Additionally, the second bristle carrier 270 includes a plurality of intermediate tufts 276 disposed between the tall tufts 274 and the composite tuft 272 of the second bristle carrier 270. The intermediate tufts 276 have a height between that of the tall tufts and the composite tuft 272 and are disposed along the sides of the composite tuft 272. The intermediate tufts 276 are disposed adjacent at least some of the perimeter of the composite tuft 272 to form a second recessed region 279. The first and second recessed regions are disposed in close proximity so that an essentially unitary composite recessed region extending between the first and second bristle carriers is formed. The dimensions and spacing of the composite tufts, intermediate tufts, and tall tufts may be further varied as discussed elsewhere herein.

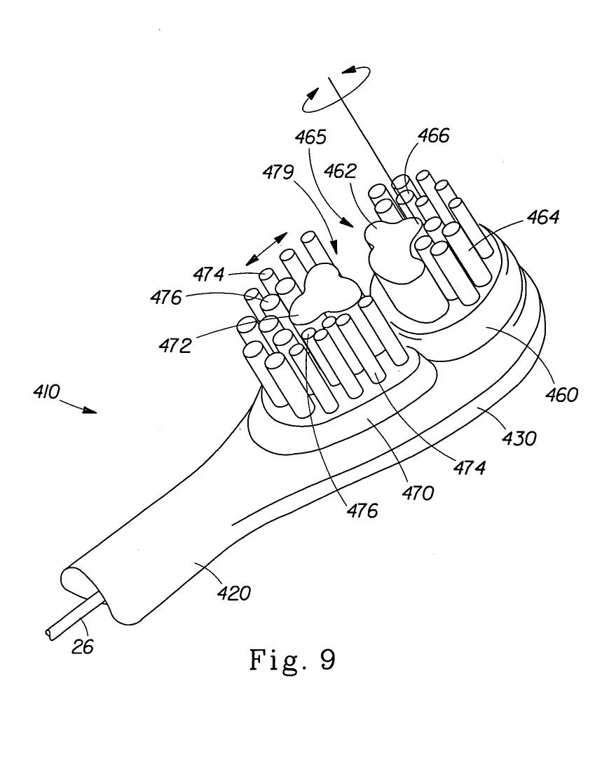

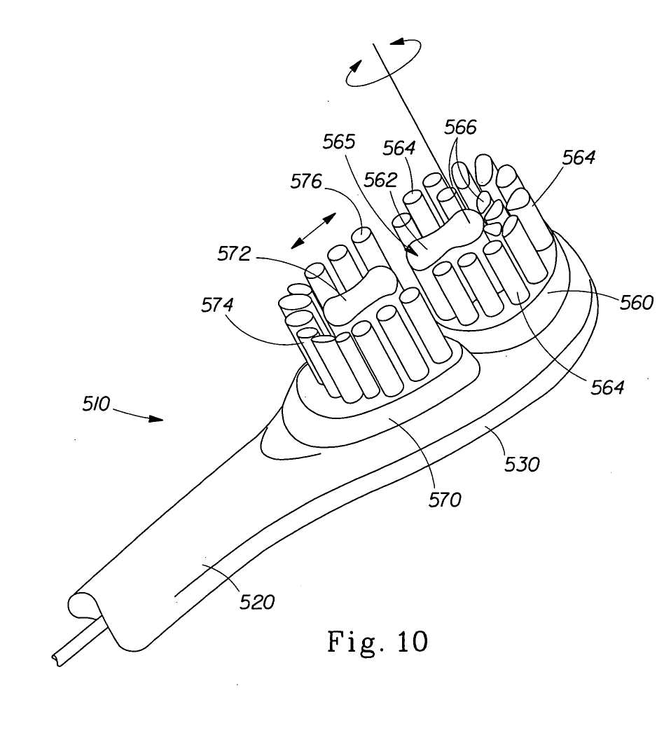

FIG. 9 is a perspective view of another toothbrush 410 in accordance with the present invention. The toothbrush 410 comprises an elongated body having a handle, a head 430, and a neck 420, extending between the handle and the head 430, as previously shown and described with respect to FIG. 1. The toothbrush 410 further includes a first bristle carrier 460 and a second bristle carrier 470 located adjacent the neck 420. The first bristle carrier 460 oscillates about an axis perpendicular to the longitudinal axis of the toothbrush and/or head, and the second bristle carrier 470 reciprocates in a direction along the longitudinal axis of the toothbrush and/or head, although other motions can be provided. A portion of a first composite tuft 462 is located at the rearward-most portion of the first bristle carrier 460 and, preferably, extends into the interior of the first bristle carrier 460. The composite tuft 462 is arcuate. A plurality of tall tufts 464 having a height that is greater than the height of the composite tuft 462 are disposed about the periphery of the first bristle carrier 460. Intermediate tufts 466 can be provided between the tall tufts 464 and the composite tuft 462. The intermediate tufts 466 have a height that is between the height of the tall tufts 464 and the composite tuft 462. Some of the intermediate tufts and/or the tall tufts 464 can be provided about a portion of the perimeter of the first composite tuft 462. Preferably, the intermediate and/or tall tufts are provided adjacent the forward portion of the perimeter and not adjacent the reward portion of the perimeter so as to form a first recessed region 465. Alternatively, tall and/or intermediate tufts might be placed at the forward-most portion of the second bristle carrier adjacent the first composite tuft 462 so as to further define the first recessed region 465. The composite tuft 462 has a top surface that forms a floor of the first recessed region 465 which helps retain a dentifrice material in the first recessed region 465 of the bristle carrier 460.

The second bristle carrier 470 optionally includes an arcuate second composite tuft 472 which is disposed along a forward region or forward and interior region of the second bristle carrier 470. The second bristle carrier 470 further includes a plurality of tall tufts 474 arranged along the outer periphery of the second bristle carrier 470. Additionally, the second bristle carrier 470 further includes a plurality of intermediate tufts 476 disposed between the tall tufts 474 and the composite tuft 472. The intermediate tufts 476 have a height between the height of the tall tufts 474 and the composite tuft 472. Some of the intermediate tufts 476 and/or the tall tufts 474 can be provided about a portion of the perimeter of the second composite tuft 472. Preferably, the intermediate and/or tall tufts are provided adjacent the rearward portion of the perimeter and not adjacent the forward portion of the perimeter so as to form a second recessed region 479. Alternatively, tall and/or intermediate tufts might be placed at the rearward-most portion of the first bristle carrier adjacent the second composite tuft 462 so as to further define the second recessed region 479. Preferably, however, the first and second recessed regions and first and second composite tufts are arranged in close proximity so that an essentially composite recessed region extending from the first bristle carrier to the second bristle carrier is formed. The second composite tuft 472 has a top surface that forms a floor of a recessed region 479 which helps retain a dentifrice material in the second recessed region 479 of the second bristle carrier 470. The dimensions and spacing of the composite tufts, intermediate tufts, and tall tufts may be further varied as discussed elsewhere herein.

FIG. 10 is a perspective view of yet another toothbrush 510 in accordance with the present invention. The toothbrush 510 comprises an elongated body having a handle, a head 530, and a neck 520, extending between the handle and the head 530, as previously shown and described with respect to FIG. 1. The toothbrush 510 further includes a first bristle carrier 560 and a second bristle carrier 570 located adjacent the neck 520. The first bristle carrier 560 oscillates about an axis perpendicular to the longitudinal axis of the toothbrush and/or head, and the second bristle carrier 570 reciprocates in a direction along the longitudinal axis of the toothbrush and/or head, although other motions can be provided. The first bristle carrier 560 includes a composite tuft 562. The first bristle carrier 560 further includes a plurality of tall tufts 564. Preferably, the tall tufts 564 are disposed at the forward-most portion of the first bristle carrier 560 and/or along the sides thereof. At least some, and preferably substantially all, the free ends of one or more of the tall tufts 565 at the forward-most portion of the first bristle carrier 560 form an inclined plane that faces toward the handle of the toothbrush 510. In other words, the free ends of the bristles of the tall tufts increase in height in a direction toward the forward-most portion of the first bristle carrier 560. Tall tufts 566 disposed along the sides of the first bristle carrier 560 may have free ends which form a plane perpendicular to the direction of the tuft (as shown in FIG. 10) or, alternatively, might form an inclined plane as well. Intermediate tufts 566 are disposed adjacent a portion of the periphery of the first bristle carrier 560. The intermediate tufts 566 have an average height that is between the height of the tall tufts 564 and the first composite tuft 562. Preferably, the inclined planes of the intermediate tufts 566 in combination with the inclined planes of the tall tufts 564 form a generally unitary or composite inclined surface. At least some of the intermediate tufts 566 and/or the tall tufts 564 are disposed adjacent a portion of the perimeter of the first composite tuft 562 to form a first recessed region 565. Preferably, the rearward portion of the first composite tuft 562 does not have tall or intermediate tufts disposed against its perimeter.

The second bristle carrier 570 is arranged in a similar manner to the tufts of the first bristle carrier 560. A second composite tuft 572 is disposed along an interior and forward region of the face of the second bristle carrier 570. The second carrier 570 further includes a plurality of tall tufts 574 disposed at the rearward-most portion of the second bristle carrier 570. At least some, and preferably substantially all, the free ends of one or more of the tall tufts 574 form an inclined plane that faces away the handle of the toothbrush 510. In other words, the free ends of the bristles of the tall tufts increase in height in a direction toward the rearward most portion of the second bristle carrier 570. The tall tufts 574 are disposed adjacent a portion of the perimeter of the second composite tuft 572 to form a second recessed region 579. Preferably, tall tufts 574 are not disposed adjacent the forward portion of the perimeter of the second composite tuft 572 so that the first and second recessed regions form a composite elongate recessed region extending from the first bristle carrier to the second bristle carrier. The dimensions and spacing of the composite tufts, intermediate tufts, and tall tufts may be varied as previously described.

It will be appreciated that the toothbrushes of the present invention may have one or more groups or tufts of static bristles or other cleaning members may be provided in conjunction with the moving bristles. Static bristles might be provided between the bristle carriers or the static bristles might partially or completely encircle one or more of the bristle carriers. While the bristle carriers have been illustrated for simplicity with tufts of bristles that extend in a direction substantially perpendicular to the longitudinal axis of the bristle carrier from which they extend, it is contemplated that the bristles might be arranged differently. Some or all of the bristles might extend in a direction which forms an acute angle with a top surface of the bristle carrier, and may extend in a forward or rearward direction. In another embodiment, some of the bristles might extend outwardly away from the head, in another direction, again forming an acute angle with respect to the top surface of the bristle carrier. Other elastomeric bristles or bristles of varying height might also be used, such as described in U.S. Pat. Nos. Des. 330,286 and Des. 434,563. Other bristle arrangements suitable for use include those arrangements described in whole or part in U.S. Pat. Nos. 6,006,394; 4,081,876; 5,046,213; 5,335,389; 5,392,483; 5,446,940; 4,894,880; and International Publication No. WO99/23910.

The housing and the brush head may be formed from a wide array of polymers. In the following description of the preferred polymer materials for use herein, the abbreviations that are commonly used by those of skill in the art to refer to certain polymers appear in parentheses following the full names of the polymers. The polymer is preferably polypropylene (“PP”), or may be selected from the group consisting of other commercially available materials, such as polystyrene (“PS”), polyethylene (“PE”), acrylonitrile-styrene copolymer (“SAN”), and cellulose acetate propionate (“CAP”). These materials may be blended with one or more additional polymers including a thermoplastic elastomer (“TPE”), a thermoplastic olefin (“TPO”), a soft thermoplastic polyolefin (e.g., polybutylene), or may be selected from other elastomeric materials, such as etheylene-vinylacetate copolymer (“EVA”), and ethylene propylene rubber (“EPR”). Examples of suitable thermoplastic elastomers herein include styrene-ethylene-butadiene-styrene (“SEBS”), styrene-butadiene-styrene (“SBS”), and styrene-isoprene-styrene (“SIS”). Examples of suitable thermoplastic olefins herein include polybutylene (“PB”), and polyethylene (“PE”). Techniques known to those of skill in the art, such as injection molding, can be used to manufacture the toothbrush of the present invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An electric toothbrush comprising:
an elongate body having a handle, a head, and a neck extending between said handle and said head, said body defining an interior chamber;
a motor within said chamber and shaft operatively connected to said motor;
a first movable bristle carrier disposed on said head, said shaft operatively connected to said first bristle carrier to impart motion thereto, said first bristle carrier having a first composite tuft formed from a plurality of closely spaced bristle tufts and a plurality of second bristle tufts, wherein said second tufts have a height that is greater than a height of said first composite tuft, said bristles of said first composite tuft having free ends and said bristles of said second tufts having free ends, wherein the total surface area of said bristles of said first composite tuft is greater than the total surface area of said bristles of said second tufts, and wherein said plurality of second tufts are disposed adjacent a portion of a perimeter of said composite tuft to form a first recessed region; and
a second moveable bristle carrier operatively connected to said shaft, said second moveable bristle carrier comprising a second composite tuft.

2. The electric toothbrush of claim 1, wherein said plurality of second tufts are disposed on opposing sides of said perimeter of said first composite tuft.

3. The electric toothbrush of claim 1, wherein said plurality of second tufts are disposed adjacent at least about 80% of said perimeter of said first composite tuft.

4. The electric toothbrush of claim 1, wherein said plurality of second tufts completely encircle said perimeter of said composite tuft.

5. The electric toothbrush of claim 1, wherein said first composite tuft has an elongate side in a top plan view.

6. The electric toothbrush of claim 5, wherein said first bristle carrier is circular in plan view and wherein said elongate side is aligned in a radial direction of said first bristle carrier.

7. The electric toothbrush of claim 1, wherein said first bristle carrier oscillates about an axis generally perpendicular to a longitudinal axis of said head.

8. The electric toothbrush of claim 1, wherein said first bristle carrier comprises a plurality of said first composite tufts.

9. The electric toothbrush of claim 1, wherein said first composite tuft has an irregular end surface.

10. The electric toothbrush of claim 1, wherein some of said plurality of second tufts have a first height and some of said plurality of second tufts have a second height greater than said first height.

11. The electric toothbrush of claim 8, wherein said height of said first composite tuft is between about 0.5 mm and about 2 mm less than said height of second tufts.

12. The electric toothbrush of claim 1, wherein said second movable bristle carrier comprises a plurality of third bristle tufts, wherein said third tufts have a height that is greater than a height of said second composite tuft, wherein said plurality of third tufts are disposed adjacent a portion of a perimeter of said second composite tuft to form a second recessed region.

13. The electric toothbrush of claim 12, wherein said first recessed region and said second recessed region form a composite recessed region extending from said first movable bristle carrier to said second movable bristle carrier.
